(19) United States
(12) Patent Application Publication
(10) Pub. No.: US 2018/0255514 A1
(43) Pub. Date: Sep. 6, 2018

(54) DYNAMIC FREQUENCY SELECTION CHANNEL FRIENDLY WAKE-UP RADIO OPERATIONS

(71) Applicant: QUALCOMM Incorporated, San Diego, CA (US)

(72) Inventors: Yanjun SUN, San Diego, CA (US); Bin TIAN, San Diego, CA (US); George CHERIAN, San Diego, CA (US); Alfred ASTERJADHI, San Diego, CA (US); Stephen Jay SHELLHAMMER, Ramona, CA (US)

(21) Appl. No.: 15/909,074

(22) Filed: Mar. 1, 2018

Related U.S. Application Data
(60) Provisional application No. 62/467,790, filed on Mar. 6, 2017.

(51) Int. Cl. H04W 52/02; H04B 1/7156

(52) U.S. Cl. CPC H04W 52/0229; H04B 1/7156; H04B 2001/71563; H04B 2201/70701; H04W 52/0235

(57) ABSTRACT

Techniques and apparatus for wake-up radio (WUR) operations are provided. One technique includes communicating with one or more wireless devices via a first radio operating on a first channel. A WUR is operated on a second channel different from the first channel. A wireless device may receive an indication of the second channel to use for monitoring for WUR transmission, and monitor for a WUR transmission on the second channel after receiving the indication.

### CROSS-REFERENCE TO RELATED APPLICATION

This application claims the benefit of and priority to U.S. Provisional Patent Application Ser. No. 62/467,790, filed Mar. 6, 2017, which is assigned to the assignee hereof and hereby expressly incorporated by reference herein.

### BACKGROUND

### I. Field of the Disclosure

Certain aspects of the present disclosure generally relate to wireless communications and, more particularly, to techniques for wake-up radio (WUR) operations.

### II. Description of Related Art

In order to address the issue of increasing bandwidth requirements demanded for wireless communications systems, different schemes are being developed to allow multiple user terminals to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≤min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In such systems, there may be a number of low power devices and/or Internet of Things (IoT) devices. These devices may include industrial sensors, remote devices, wearable devices (e.g., smart watch, smart glasses, smart bracelet, smart ring, etc.) medical devices or equipment, biometric sensors/devices, home smart devices, etc. To reduce power consumption, these devices generally attempt to maintain a low powered state, periodically waking up to receive/transmit information. However, as the demand for prolonging the battery life of these devices continues to increase, there exists a need for further improvements to power efficient mechanisms for these devices.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide a method for wireless communications by an apparatus. The method generally includes communicating with one or more wireless devices via a first radio operating on a first channel. The method also includes operating a wake-up radio (WUR) on a second channel different from the first channel.

Certain aspects of the present disclosure provide an apparatus for wireless communications. The apparatus generally includes at least one interface configured to communicate with one or more wireless devices via a first radio operating on a first channel. The apparatus also includes a processing system configured to operate a wake-up radio (WUR) on a second channel different from the first channel.

Certain aspects of the present disclosure provide an apparatus for wireless communications. The apparatus generally includes means for communicating with one or more wireless devices via a first radio operating on a first channel. The apparatus also includes means for operating a wake-up radio (WUR) on a second channel different from the first channel.

Certain aspects of the present disclosure provide a computer readable medium having computer executable code stored thereon for wireless communications by an apparatus. The computer executable code includes code for communicating with one or more wireless devices via a first radio operating on a first channel, and code for operating a wake-up radio (WUR) on a second channel different from the first channel.

Certain aspects of the present disclosure provide a method for wireless communications by an apparatus. The method generally includes receiving communications from a first radio of a wireless device operating on a first channel. The method also includes receiving, from the wireless device, an indication of a second channel, different from the first channel, to use for monitoring for wake-up radio (WUR) transmissions from the wireless device. The method further includes monitoring for a WUR transmission from the wireless device on the second channel after receiving the indication.

Certain aspects of the present disclosure provide an apparatus for wireless communications. The apparatus generally includes at least one interface configured to receive communications from a first radio of a wireless device operating on a first channel. The at least one interface is also configured to receive, from the wireless device, an indication of a second channel, different from the first channel, to use for monitoring for wake-up radio (WUR) transmissions from the wireless device. The apparatus includes a processing system configured to monitor for a WUR transmission from the wireless device on the second channel after receiving the indication.

Certain aspects of the present disclosure provide an apparatus for wireless communications. The apparatus generally includes means for receiving communications from a first radio of a wireless device operating on a first channel. The apparatus also includes means for receiving, from the wireless device, an indication of a second channel, different from the first channel, to use for monitoring for wake-up radio (WUR) transmissions from the wireless device. The apparatus further includes means for monitoring for a WUR transmission from the wireless device on the second channel after receiving the indication.

Certain aspects of the present disclosure provide a computer readable medium having computer executable code stored thereon for wireless communications by an apparatus. The computer executable code includes code for receiving communications from a first radio of a wireless device operating on a first channel. The computer executable code also includes code for receiving, from the wireless device, an indication of a second channel, different from the first channel, to use for monitoring for wake-up radio (WUR) transmissions from the wireless device. The computer executable code further includes code for monitoring for a WUR transmission from the wireless device on the second channel after receiving the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 illustrates an example protection/co-existence mechanism for WUR operation, in accordance with certain aspects of the present disclosure

FIG. 4 illustrates another example protection/co-existence mechanism for WUR operation, in accordance with certain aspects of the present disclosure

FIG. 5 illustrates example operations for performing WUR operations, in accordance with certain aspects of the present disclosure.

FIG. 5A illustrates example components capable of performing the operations shown in FIG. 5.

FIG. 6 illustrates example operations for monitoring for WUR transmissions, in accordance with certain aspects of the present disclosure.

FIG. 6A illustrates example components capable of performing the operations shown in FIG. 6.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Certain aspects of the present disclosure provide methods and apparatus for dynamic frequency selection (DFS) friendly wake-up radio (WUR) operations. As described below, an apparatus may use the techniques described herein to operate a WUR on a channel that is different from the channel that the main radio is operating on. The WUR may include a WUR receiver and/or WUR transmitter. In some aspects, if the main radio is operating on a DFS channel, the apparatus may select a non-DFS channel or another DFS channel to operate the WUR on. In some aspects, if the apparatus is configured with a plurality of radios, the apparatus may designate the WUR to use a non-DFS channel that one of the plurality of radios is operating on.

In this manner, an apparatus can use the techniques presented herein to reduce (or prevent) certain apparatuses (e.g., legacy access points) that may be operating on a DFS channel from falsely detecting a WUR signal (from the apparatus) as a radar signal. Such false detection, for example, can stop the access point's normal operation for a significant amount of time, reducing the performance of the access point.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

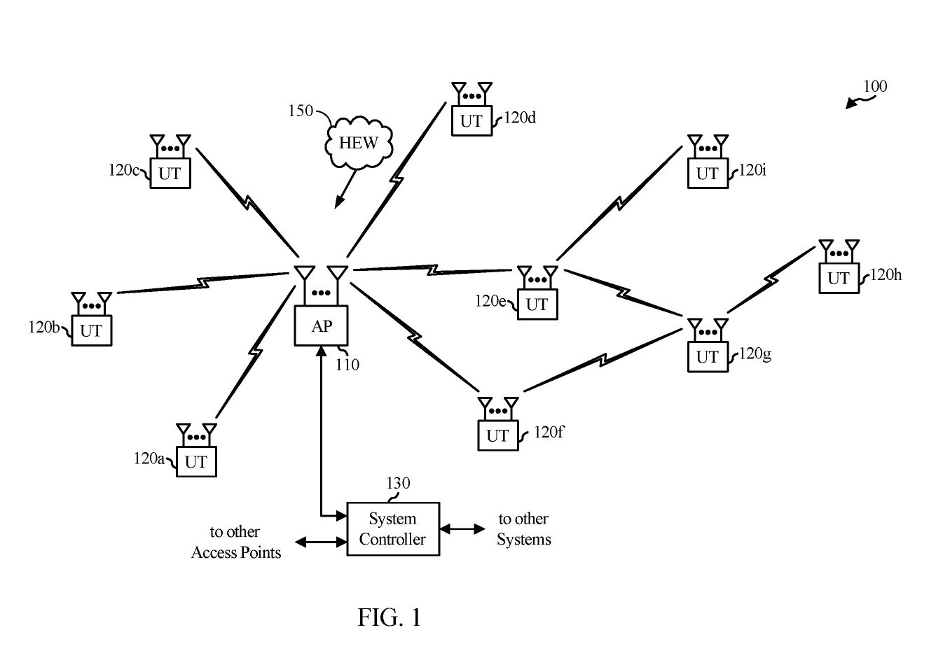

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≤1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

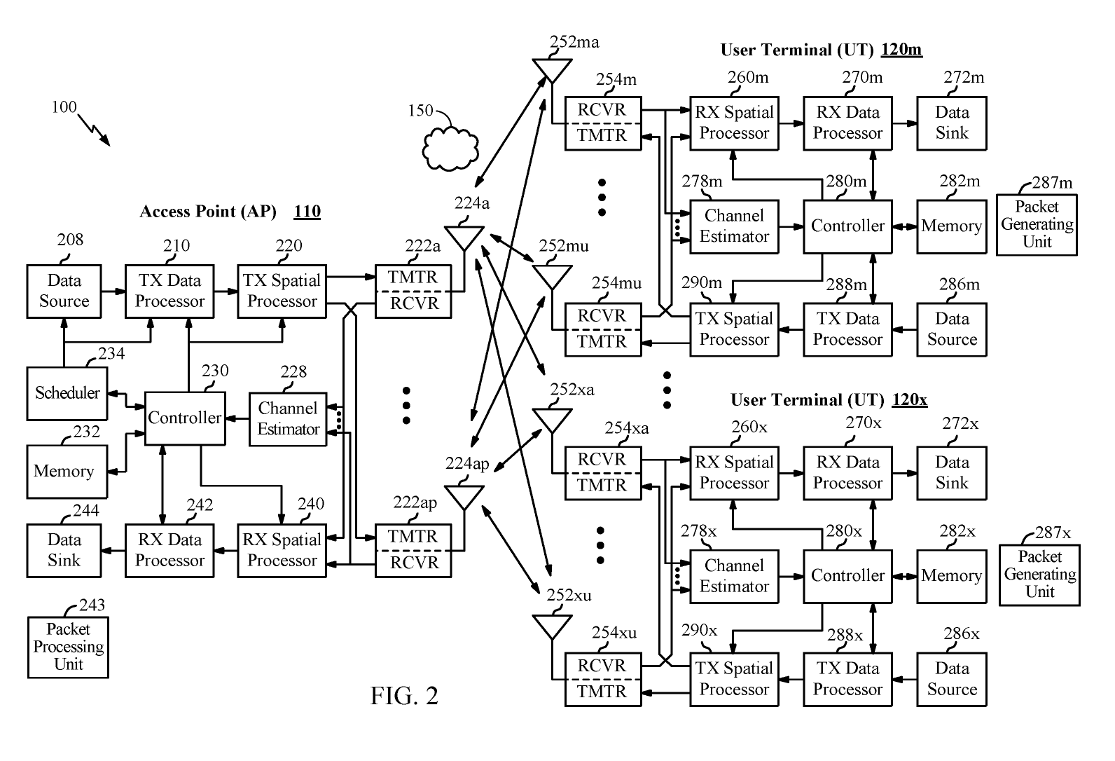

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

In FIGS. 1 and 2, one or more user terminals 120 may send one or more High Efficiency WLAN (HEW) packets 150 to the access point 110 as part of a UL MU-MIMO transmission, for example. Each HEW packet 150 may be transmitted on a set of one or more spatial streams (e.g., up to 4). For certain aspects, the preamble portion of the HEW packet 150 may include tone-interleaved LTFs, subband-based LTFs, or hybrid LTFs.

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After UL transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

Many devices in the communication system may be low power devices, IoT devices, etc. These devices typically consume a reduced amount of power (e.g., compared to other devices) and are usually powered by a battery. To reduce power consumption, low power devices generally attempt to stay in the sleep state as long as possible, periodically waking up to transmit/receive data. The longer the devices stay in the sleep state, the lower power the devices may consume. However, at the same time, staying in the sleep state for a long period of time can result in increased latency in data reception.

### Example Wake-Up Radio Operation

Certain standards, such as the IEEE 802.11ba standard, provide additional capabilities/enhancements to wireless communications that operate in accordance with existing 802.11 standards. One example feature to be included in such standards (e.g., IEEE 802.11ba) includes operation of a wake-up radio (WUR) in addition to a primary main radio (e.g., 802.11 radio). WUR operation can enable energy efficient data reception without increasing latency. For example, an apparatus (e.g., AP/UT) can use the WUR as a companion radio (transmitter/receiver) to the apparatus's primary/dedicated radio (transmitter/receiver). The apparatus may maintain the primary radio in an off state (or low powered state).

Once the apparatus detects via the WUR receiver that it has data pending, the apparatus can use the WUR to wake-up the primary radio. The apparatus may use the primary radio to retrieve the data and then go back to sleep. The WUR receiver may have an active receive power consumption of less than one milliwatt (e.g., compared to an active receive power consumption of tens of milliwatts associated with the primary radio). The AP 110 and/or UT 120 in FIGS. 1-2 may include a WUR in addition to a primary/dedicated radio, and may use the techniques described herein for WUR operations.

WUR devices may co-exist with legacy IEEE 802.11 devices in the same band. To ensure co-existence, WUR transmissions may have to be protected from legacy 802.11 devices. For example, an apparatus (e.g., AP or UT) may silence other devices in proximity to the apparatus prior to sending a WUR transmission (e.g., a transmission to a device with a WUR). A number of methods exist for protecting WUR transmissions from legacy 802.11 operation.

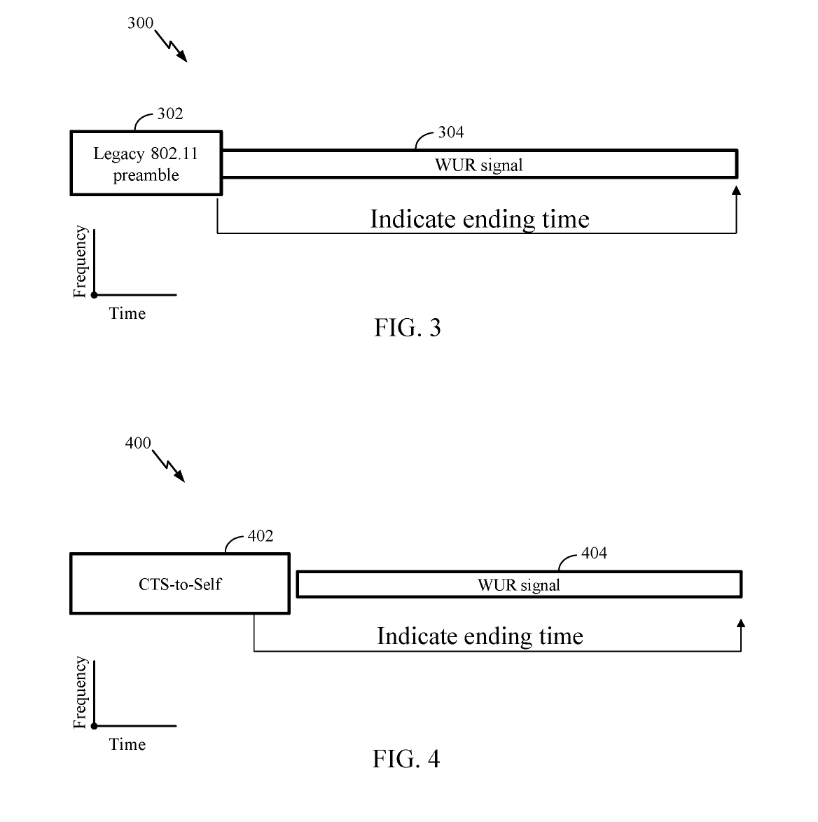

FIG. 3 illustrates one example of a protection/co-existence mechanism 300 based on L-SIG length information in a legacy 802.11 preamble, in accordance with certain aspects of the present disclosure. As shown, in order to have WUR operation co-exist with legacy 802.11 operation, an apparatus may first transmit a L-SIG preamble 302 to silence the network. The L-SIG preamble may indicate the ending time of the subsequent WUR signal 304. After transmitting the L-SIG preamble 302, the apparatus may then transmit the WUR signal 304 (e.g., to another device with a WUR).

FIG. 4 illustrates another example of a protection/co-existence mechanism 400 based on NAV field of a clear-to-send (CTS)-to-Self packet, in accordance with certain aspects of the present disclosure. As shown, in order to have WUR operation co-exist with legacy 802.11 operation, an apparatus may first transmit a CTS-to-Self message 402 to silence the network. The CTS-to-Self message 402 may indicate (e.g., via the NAV field or some other field) the ending time of the subsequent WUR signal 404. After transmitting the CTS-to-Self message 402, the apparatus may transmit the WUR signal 404 (e.g., to another device with a WUR).

However, while the co-existence mechanisms shown in FIGS. 3-4 may be used to protect WUR transmissions, these co-existence mechanisms may cause false radar detection problems for devices operating on DFS channels. As shown in FIG. 3, for example, the legacy 802.11 preamble 302 has a larger bandwidth than the WUR signal 304. Similarly, in FIG. 4, the CTS-to-Self message 402 has a larger bandwidth than the WUR signal 404. In some cases, the preamble 302 and CTS-to-Self message 402 may use a bandwidth of 20 MHz compared to the WUR signals 304/404 bandwidth of a few MHz. In addition, there may be a substantial power difference between the preamble 302/CTS-to-Self 402 and the subsequent WUR signals 304/404, respectively. In some cases, the energy/bandwidth changes in the above mechanisms (e.g., between the legacy portions and the subsequent WUR signals) may cause a legacy AP to falsely detect the WUR signals as radar in a DFS channel.

For example, one key distinction generally used to distinguish between WLAN signals and radar is the bandwidth of the signal. WLAN signals in 5 GHz (e.g., 802.11a/n/ac) have generally been at least 20 MHz wide. Radar signals, on the other hand, generally use a tone. Chirping radars, for example, may have time varying tone frequency. But at a given time, chirping radars may also resemble narrow band signals. As a result, this distinction can greatly reduce the probability of correctly declaring a (potential) radar pulse from a WLAN signal (in DFS channels). In addition, the waveform used for WUR signals may also contribute to the false detection in DFS channels. On-Off Keying (OOK), for example, may be one modulation scheme used for WUR. OOK signals, however, generally have many rising/falling edges similar to radar pulses.

Each time that an AP detects radar while operating in a DFS channel, the AP may have to stop operation for a minimal of thirty minutes. Doing so, however, can significantly impact communications in the network. Accordingly, aspects presented herein provide techniques for WUR operations that can prevent false radar detections at devices operating on a DFS channel.

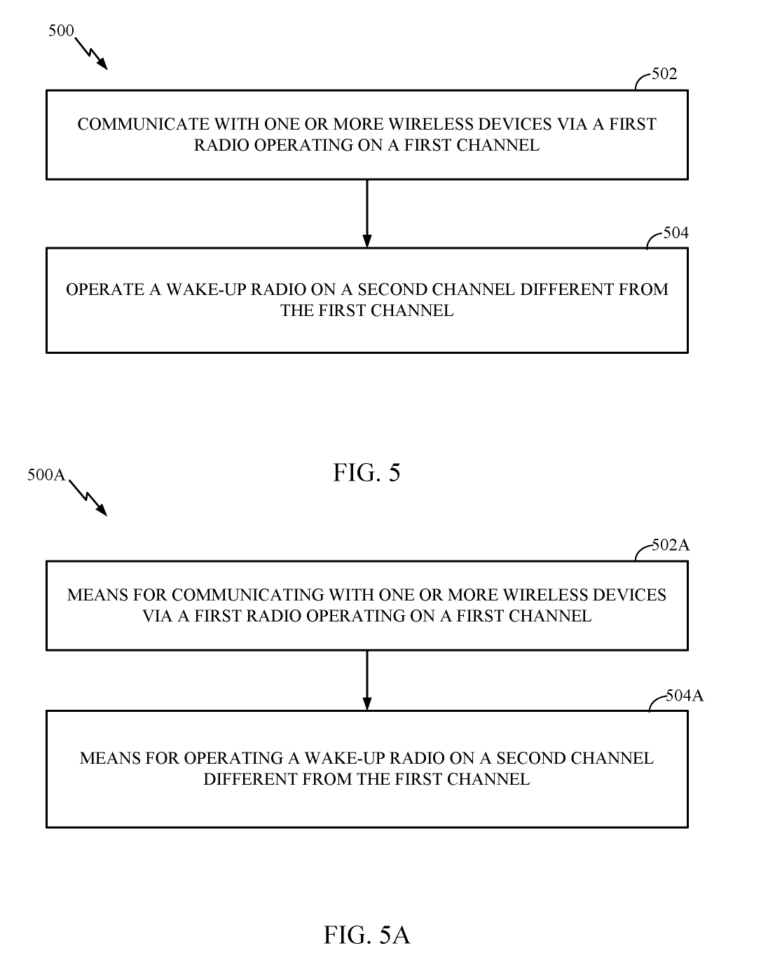

FIG. 5 illustrates example operations 500 for performing WUR operations, in accordance with certain aspects of the present disclosure. The operations 500, for example, may be performed by an apparatus (e.g., AP/BS 110, or UT 120 in the case of UT to UT communication).

The operations 500 begin, at 502, where the apparatus communicates with one or more wireless devices via a first (main) radio operating on a first channel. The first radio, for example, may be a primary communication radio of the apparatus used for transmitting/receiving data packets. At 504, the apparatus operates a WUR on a second channel different from the first channel. The WUR may be dedicated for sending WUR signals to a WUR of another apparatus, e.g., to wake up the other apparatus. In some aspects, the WUR may be a part of the first radio. In some aspects, the WUR may be different from the first radio.

According to certain aspects, the WUR may operate on a different channel in the same or different band from the main radio. That is, the first channel and the second channel may be in the same frequency band or in different frequency bands. In some aspects, the first channel may be a DFS channel. If the apparatus (e.g., AP) operates its main radio on a DFS channel, the AP may determine to conduct WUR transmissions on a different (e.g., second) channel. The different (e.g., second) channel may be a non-DFS channel or a DFS channel.

In one aspect, the apparatus may signal at least one of an indication of the second channel to the wireless devices, or an indication that the apparatus will send WUR signals on the second channel. For example, the apparatus may notify its UTs via the DFS channel that WUR operations will occur on the different channel.

The apparatus may choose a number of different techniques for conducting WUR operations. In one example technique, the apparatus may signal to the wireless devices an indication of an amount of time that the apparatus will be unavailable for communication on the first channel. For example, the apparatus can indicate that it will be unavailable for a time window on the first (e.g., DFS) channel by using a CTS-to-Self or Notice of Absence frame. The length of time window may be long enough to cover the subsequent WUR operation on the second channel. After signaling the indication of the amount of time, the apparatus may tune the WUR to the second channel. Once tuned to the second channel, the apparatus may perform carrier sensing and send the WUR signal to the wireless devices. The apparatus may then tune the WUR back to the first (e.g., DFS) channel.

In some aspects, if the apparatus determines (once it has tuned back to the first channel) that the indicated amount of time has not expired, the apparatus may signal an indication to the wireless devices that the apparatus is available for communication on the first channel (e.g., DFS channel). For example, in one aspect, if the AP used a CTS-to-Self message with a NAV longer than needed, the AP may send a CF-end message to indicate to the wireless devices that the AP is once again available for communication on the first channel. In one aspect, if the AP used a notice-of-absence message whose duration is longer than needed, the AP can send a message to notify the UTs that the AP is available.

In another example technique, the apparatus may designate WUR operations to use a non-DFS channel that another radio (e.g., second radio) of the apparatus is operating on. For example, the AP may include a plurality of radios, a first set of which operate on DFS channels, and a second set of which operate on non-DFS channels. The AP may designate the second channel to one of the non-DFS channels that another (e.g., second) radio X of the AP is operating on. If multiple non-DFS channels are present, the AP may select one of the non-DFS channels to use for WUR operations based on at least one of a transmit power difference between the DFS channel and the non-DFS channel, a number of UTs camped on the second channel, or a frequency band in which the second channel is located.

For example, assuming there are two candidate non-DFS channels available for selection, the AP may choose the non-DFS channel that has the lower number of wireless devices camped on it. In another example, the AP may choose the non-DFS channel that has the larger range (e.g., radius). In another example, the AP may choose the non-DFS channel that has the least amount of TX power difference from the DFS channel. In general, the AP may use any combination of the above criteria or different criteria when selecting the non-DFS channel to use for WUR operations.

In some aspects, the AP may notify its UTs on the DFS channel to leverage WUR information (e.g., time synchronization, service periods, etc.) sent via radio X for UTs associated with radio X. For example, the AP may assign non-overlapping identifiers (IDs) to its UTs that are associated with the DFS channel and to the UTs associated with the non-DFS channel (on radio X). Doing so may allow the AP to use the same management frames (e.g., beacons, paging messages, etc.) when broadcasting to UTs operating on the different channels (e.g., as opposed to generating redundant management frames).

In some aspects, the transmitting apparatus (e.g., AP) may include one or more elements (e.g., Quiet element, Quiet Period element, Quiet Frequencies element, etc.) in transmitted beacon frames or other management frames to indicate to the receiving UTs operating in a particular channel (e.g., first or second channel) to not transmit (or cause other UTs to transmit) during certain specified periods of time (and/or frequencies) which are signaled in the included one or more elements. These periods of time (and/or frequencies) can be used by the AP to sense for the presence of radars or other incumbent technologies operating in the vicinity (e.g., within a threshold distance), or can be used for scheduling purposes in general (e.g., spectrum sharing between multiple technologies (LTE, LAA, Wi-Fi, Bluetooth, etc.)).

In some cases, however, the AP (or a neighboring AP) may unintentionally cause a UT that is not aware of such restrictions put in place by the AP (or the neighboring APs nearby) to transmit during the restricted times/frequencies. One reference example of unintentionally causing the UT to transmit (or cause other UTs to transmit) is when the transmitting apparatus sends a WUR wakeup frame to the UT in the WUR channel (which may not be located in the DFS channel, or may not be located in general in the operating channel where the restrictions are put in place). Thus, to avoid the UT transmitting during time period (and/or frequencies) where the restrictions are in place, it may be desirable to provide techniques that prevent the UT from waking up during the restricted periods of time (and/or frequencies).

According to certain aspects, the transmitting apparatus, using the techniques presented herein, can be configured to refrain from causing (e.g., by sending a WUR wakeup frame to the UT's WUR receiver) the UT to wake up during the restricted periods of time (and/or frequencies). In particular, in some aspects, the transmitting apparatus (e.g., AP) may be configured to refrain from sending a WUR wakeup frame to the receiving apparatus (e.g., UT) in the non-DFS channel to wake up the UT in the DFS channel if the AP is using a particular type of frame. For example, if the AP is including a Quiet element (or another type of element, such as Quiet period element, Quiet Frequencies element, etc.) in the beacon frame, the AP may not send a WUR wakeup frame to the UT in the non-DFS channel to wake up the UT in the DFS channel.

In some aspects, the apparatus may determine to operate the WUR on the second channel after detecting at least another apparatus (e.g., another AP) in proximity to the apparatus operating in the first channel. The apparatus may detect the other apparatus based on signals (e.g., beacons) received from the other apparatus. For example, the other apparatus may be a legacy AP (in presence of the AP sending the WUR signal) that is operating in the same DFS channel. In other aspects, the apparatus may determine to always operate the WUR on the second channel (e.g., regardless of whether it detects another apparatus operating on the second channel).

In some cases, the transmitting apparatus (e.g., AP) and receiving apparatus (e.g., UT) may encounter race conditions during WUR operations due, in part, to the first radio and WUR operating on different channels. For example, assume the UT sends an indication to the AP (via the main radio) that the UT will enter a sleep mode. After sending the indication, the UE may switch its frequency to the second (e.g., non-DFS) channel. However, the UT may encounter a delay (e.g., 200 microseconds) when switching its frequency to the second channel. In such cases, if the AP sends a wakeup frame (e.g., to the WUR receiver of the UT) during this switching delay, the wakeup frame may not be detected by the UT, which can impact the communications between the AP and UT in the network.

In some aspects, to reduce the likelihood of the UT missing (e.g., not detecting) the wakeup frame (e.g., WUR signal), the AP may delay sending a wakeup frame to the UT for a predefined period of time (e.g., after receiving an indication that the UT will enter a sleep mode), so that the AP does not send the wakeup frame while the UT is switching from the first channel to the second channel. In some cases, the AP and UT may negotiate and agree on the predefined period of time (e.g., min_channel_switch_delay) prior to WUR operation. Once agreed, the AP may refrain from sending the wakeup frame to the UT during this time.

Additionally, or alternatively, in some aspects, to reduce the likelihood of the UT missing the wakeup frame, the UT may be configured to refrain from entering a sleep mode (within a predetermined amount of time) before a WUR receive period. For example, when WUR duty cycling is in use, the UT may be configured with WUR receive periods/slots and may operate its WUR receiver (e.g., on the second channel) during the WUR receive periods. In such cases, the UT in some aspects may begin operating its WUR receiver on the second (e.g., non-DFS) channel prior to a next scheduled WUR receive period (e.g., during a non-WUR receive period). In this manner, the UT may have a better likelihood of ensuring that its WUR receiver is ready before the AP sends a wakeup frame.

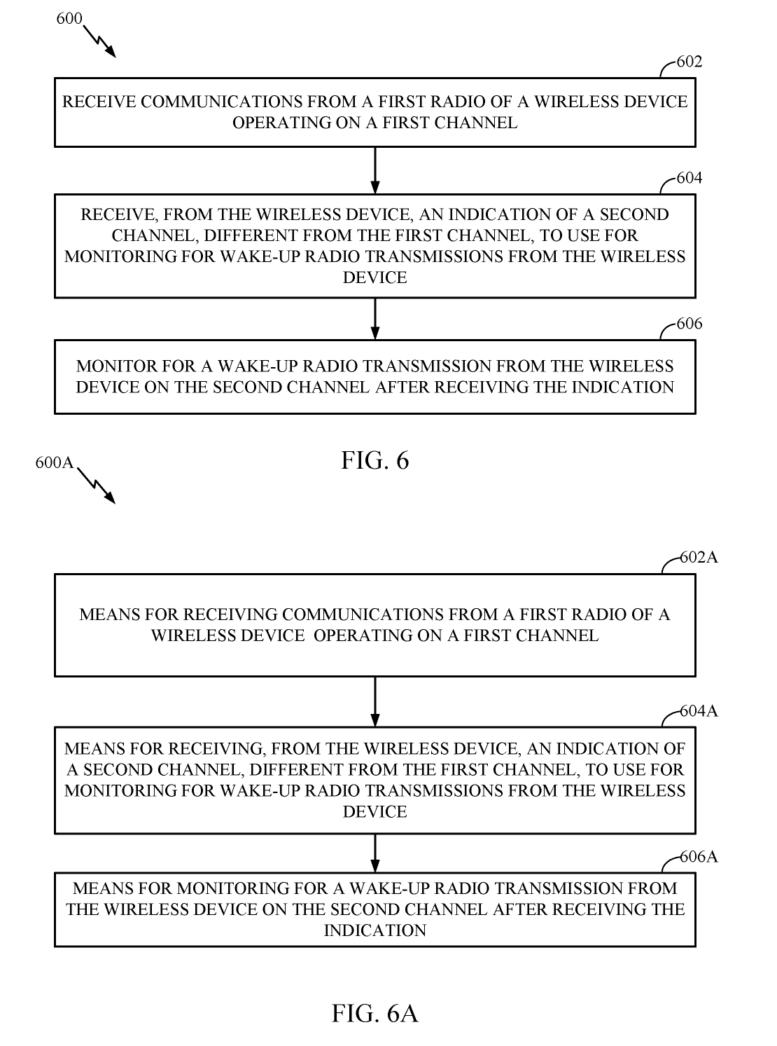

FIG. 6 illustrates example operations 600 for monitoring for WUR transmissions, in accordance with certain aspects of the present disclosure. The operations 600, for example, may be performed by an apparatus (e.g., UT 120, AP/BS 110, etc.).

The operations 600 begin, at 602, where the apparatus receives communications from a first radio of a wireless device operating on a first channel. The first radio may be a primary communication radio of the wireless device. At 604, the apparatus receives, from the wireless device, an indication of a second channel, different from the first channel, to use for monitoring for WUR transmissions from the wireless device. At 606, the apparatus monitors for a WUR transmission from the wireless device on the second channel after receiving the indication. In some aspects, the apparatus may receive an indication of an amount of time that the wireless device will be unavailable for communication on the first channel, and refrain from sending transmissions to the wireless device during the amount of time.

In one aspect, once the apparatus detects a WUR transmission from the wireless device on the second channel, the apparatus may use the WUR to wake up the first radio (e.g., which may be in an off-state or low power state). Once the first radio is active, the apparatus may use the first radio to receive any available data from the wireless device. Once the data is received, the apparatus may power down the first radio.

Advantageously, the techniques presented herein can be used to reduce (or prevent) certain apparatuses (e.g., legacy APs) that may be operating on a DFS channel from falsely detecting a WUR signal (send from another apparatus, such as an AP) as a radar signal.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 illustrated in FIG. 5 correspond to means 500A illustrated in FIG. 5A, and operations 600 illustrated in FIG. 6 correspond to means 600A illustrated in FIG. 6A.

For example, means for transmitting (or means for outputting for transmission), means for signaling, means for sending, means for indicating or means for communicating may comprise a transmitter (e.g., the transmitter unit 222) and/or an antenna(s) 224 of the access point 110 or the transmitter unit 254 and/or antenna(s) 252 of the user terminal 120 illustrated in FIG. 2. Means for receiving (or means for obtaining) or means for monitoring may comprise a receiver (e.g., the receiver unit 222) and/or an antenna(s) 224 of the access point 110 or the receiver unit 254 and/or antenna(s) 254 of the user terminal 120 illustrated in FIG. 2.

Means for processing, means for obtaining, means for generating, means for switching, means for selecting, means for decoding, means for determining, means for tuning, means for assigning, means for operating, means for detecting, means for refraining, or means for evaluating may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by an apparatus, comprising:
communicating with one or more wireless devices via a first radio operating on a first channel; and
operating a wake-up radio (WUR) on a second channel different from the first channel.

2. The method of claim 1, wherein the WUR is different from the first radio.

3. The method of claim 1, wherein the WUR is a part of the first radio.

4. The method of claim 1, wherein the first channel and the second channel are in the same frequency band.

5. The method of claim 1, wherein the first channel and the second channel are in different frequency bands.

6. The method of claim 1, wherein the first channel is a dynamic frequency selection (DFS) channel.

7. The method of claim 6, wherein the second channel is a non-DFS channel.

8. The method of claim 6, wherein the second channel is another DFS channel.

9. The method of claim 1, further comprising signaling at least one of an indication of the second channel to the one or more wireless devices or an indication that the apparatus will send WUR signals on the second channel.

10. The method of claim 9, further comprising:
signaling to the one or more wireless devices an indication of an amount of time that the apparatus will be unavailable for communication on the first channel;
tuning the WUR to the second channel after signaling the indication of the amount of time;
sending a WUR signal to the one or more wireless devices on the second channel after tuning the WUR to the second channel; and
tuning the WUR back to the first channel after sending the WUR signal.

11. The method of claim 10, wherein the indication of the amount of time is signaled via a clear-to-send (CTS)-to-self message or notice of absence message.

12. The method of claim 10, further comprising:
determining the amount of time has not expired after tuning the WUR back to the first channel; and
signaling to the one or more wireless devices an indication that the apparatus is available for communication on the first channel after determining that the amount of time has not expired.

13. The method of claim 1, wherein:
the first channel is a dynamic frequency selection (DFS) channel;
the second channel is a non-DFS channel used by a second radio of the apparatus; and
the second radio is different from the first radio.

14. The method of claim 13, wherein the second channel is selected from a plurality of available non-DFS channels based on at least one of a transmit power difference between the second channel and the first channel, a number of wireless devices camped on the second channel, or a frequency band in which the second channel is located.

15. The method of claim 13, further comprising:
assigning non-overlapping identifiers to a first one or more wireless devices associated with the first channel and a second one or more wireless devices associated with the second channel.

16. The method of claim 1, wherein operating the WUR on the second channel occurs after detecting at least another apparatus, in proximity to the apparatus, operating in the first channel.

17. The method of claim 1, further comprising
receiving an indication from at least one of the one or more wireless devices that the at least one wireless device will enter a sleep mode; and
refraining from sending a WUR signal to the at least one wireless device on the second channel for a period of time after receiving the indication.

18. The method of claim 17, wherein the period of time is a predefined period of time agreed to by the apparatus and the at least one wireless device.

19. A method for wireless communications by an apparatus, comprising:
receiving communications from a first radio of a wireless device operating on a first channel;
receiving, from the wireless device, an indication of a second channel, different from the first channel, to use for monitoring for wake-up radio (WUR) transmissions from the wireless device; and
monitoring for a WUR transmission from the wireless device on the second channel after receiving the indication.

20. The method of claim 19, wherein the first channel and the second channel are in the same frequency band.

21. The method of claim 19, wherein the first channel and the second channel are in different frequency bands.

22. The method of claim 19, wherein the first channel is a dynamic frequency selection (DFS) channel.

23. The method of claim 22, wherein the second channel is a non-DFS channel.

24. The method of claim 22, wherein the second channel is another DFS channel.

25. The method of claim 19, further comprising:
receiving an indication of an amount of time that the wireless device will be unavailable for communication on the first channel; and
refraining from sending transmissions to the wireless device during the amount of time.

26. The method of claim 25, wherein the indication of the amount of time is received via a clear-to-send (CTS)-to-self message or notice of absence message.

27. The method of claim 19, wherein:
the first channel is a dynamic frequency selection (DFS) channel;
the second channel is a non-DFS channel used by a second radio of the wireless device; and
the second radio is different from the first radio.

28. The method of claim 19, wherein monitoring for the WUR transmission comprises monitoring for the WUR transmission prior to a WUR receive period of the apparatus.

29. An apparatus for wireless communications, comprising:
means for communicating with one or more wireless devices via a first radio operating on a first channel; and
means for operating a wake-up radio (WUR) on a second channel different from the first channel.

30. An apparatus for wireless communications, comprising:
means for receiving communications from a first radio of a wireless device operating on a first channel;
means for receiving, from the wireless device, an indication of a second channel, different from the first channel, to use for monitoring for wake-up radio (WUR) transmissions from the wireless device; and
means for monitoring for a WUR transmission from the wireless device on the second channel after receiving the indication.
